(19) United States
(12) Patent Application Publication
(10) Pub. No.: US 2020/0059889 A1
(43) Pub. Date: Feb. 20, 2020

(54) TERMINAL APPARATUS, LOCATION SERVER, AND METHOD IN TERMINAL APPARATUS

(71) Applicant: SHARP KABUSHIKI KAISHA, Sakai City, Osaka (JP)

(72) Inventors: KATSUYA KATO, Sakai City, Osaka (JP); RYOTA YAMADA, Sakai City, Osaka (JP); YASUHIRO HAMAGUCHI, Sakai City, Osaka (JP)

(21) Appl. No.: 16/610,235

(22) PCT Filed: May 11, 2018
(86) PCT No.: PCT/JP2018/018434

§ 371 Date: Nov. 1, 2019

(30) Foreign Application Priority Data
May 11, 2017 (JP) 2017-094569

(51) Int. Cl. H04W 64/00; H04B 7/06; H04B 7/08

(52) U.S. Cl. CPC H04W 64/006; H04B 7/088; H04B 7/0617

(57) ABSTRACT

A terminal apparatus (20) includes: a first direction configuring unit configured to receive transmission beam information that is information of a transmission beam used by a transmission device (10-m) and configure a first direction (102-m) that is a direction vector of the transmission beam in a first coordinate system based on the transmission beam information; a radio receiving unit configured to configure a reception beam used for reception of a signal from the transmission device; a second direction configuring unit configured to configure a second direction (202-m) that is a direction vector of the reception beam in a second coordinate system; and an orientation measuring unit configured to perform measurement of an orientation of the terminal apparatus itself based on the first direction (102-m) and the second direction (202-m).

### TECHNICAL FIELD

The present invention relates to a terminal apparatus, a location server, and a method in the terminal apparatus.

This application claims priority based on JP 2017-94569 filed on May 11, 2017, the contents of which are incorporated herein by reference.

### BACKGROUND ART

In a communication system such as Long Term Evolution (LTE) or LTE-Advanced (LTE-A) standardized by the Third Generation Partnership Project (3GPP), the communication area can be widened by forming a cellular configuration in which multiple areas, covered by base station apparatuses (base stations, transmission stations, transmission points, downlink transmission devices, uplink reception devices, a group of transmit antennas, a group of transmit antenna ports, component carriers, eNodeB, Access Point, AP, transmission devices) or transmission stations equivalent to the base station apparatuses, are deployed in the form of multiple cells (Cells). A terminal apparatus (reception station, reception point, downlink reception apparatus, uplink transmission apparatus, receive antenna group, receive antenna port group, UE, station, and STA) is connected to the base station apparatus. In such a cellular configuration, frequency efficiency can be improved by using the same frequency among neighboring cells or sectors. In the future, a specification for communication using high frequency bands such as millimeter waves is planned to be formulated for further data rate improvement. Beamforming is assumed in the communication in the high frequency band. PTL 1 discloses an operation method for beamforming by beam sweeping.

Additionally, in LTE and LTE-A, a method for performing terminal position estimation is specified. In the future, position estimation using the high frequency band is also considered to be introduced. NPL 1 discloses a method for position estimation using a signal in a 60 GHz band.

On the other hand, in recent years, fields such as Augmented Reality (AR), Virtual Reality (VR), and robots have expanded rapidly. In such a field, it is necessary to estimate not only a position but also an orientation, of an AR/VR terminal or the robot with high accuracy.

### CITATION LIST

### Patent Literature

PTL 1: JP 2016-506112 T
NPL 1: A. P. Toda et al., “Beamforming antennas for 60 GHz positioning systems,” EuCAP 2014, April 2014, pp. 630-633.

### SUMMARY OF INVENTION

### Technical Problem

However, the position estimation method disclosed in NPL 1 has a problem that the orientation of the terminal cannot be estimated.

An aspect of the present invention has been made in view of such circumstances, and an object of the present invention is to provide a terminal apparatus, a location server, and a method in the terminal apparatus, capable of estimating an orientation of the terminal with high accuracy.

### Solution to Problem

To address the above-mentioned drawback, a terminal apparatus, a location server, and a method in the terminal apparatus according to an aspect of the present invention are configured as follows.

A terminal apparatus according to an aspect of the present invention includes: a first direction configuring unit configured to receive transmission beam information that is information of a transmission beam used by a transmission device and configure a first direction that is a direction vector of the transmission beam in a first coordinate system based on the transmission beam information; a radio receiving unit configured to configure a reception beam used for reception of a signal from the transmission device; a second direction configuring unit configured to configure a second direction that is a direction vector of the reception beam in a second coordinate system; and an orientation measuring unit configured to perform measurement of an orientation of the terminal apparatus itself based on the first direction and the second direction.

Furthermore, in the terminal apparatus according to the aspect of the present invention, the transmission beam information may be an azimuth angle and an elevation angle of the transmission beam used by the transmission device, in the first coordinate system, and the first direction configuring unit may configure the first direction based on the azimuth angle and the elevation angle.

Furthermore, in the terminal apparatus according to the aspect of the present invention, the transmission beam information may be the direction vector of the transmission beam used by the transmission device, in the first coordinate system, and the first direction configuring unit may configure the first direction based on the direction vector.

Furthermore, in the terminal apparatus according to the aspect of the present invention, the second coordinate system may be a coordinate system fixed to the orientation.

Furthermore, in the terminal apparatus according to the aspect of the present invention, the orientation measuring unit may receive beam orientation measurement information for indicating whether or not the transmission beam is used for orientation measurement, and the orientation measuring unit may perform the measurement based on the first direction and the second direction, corresponding to the transmission beam indicated by the beam orientation measurement information.

A location server according to an aspect of the present invention is a location server in a system in which multiple base station apparatuses and a terminal apparatus communicate using beamforming, the location server includes: a receiver configured to receive transmission beam information that is information of a transmission beam used by the base station apparatus and reception beam information that is information of a reception beam used by the terminal apparatus; a first direction configuring unit configured to configure a first direction that is a direction vector of the transmission beam in a first coordinate system based on the transmission beam information; a second direction managing unit configured to configure a second direction that is a direction vector of the reception beam in a second coordinate system of the terminal apparatus based on the reception beam information; and a direction managing unit configured to perform measurement of an orientation of the terminal apparatus based on the first direction and the second direction.

Furthermore, in the location server according to the aspect of the present invention, the transmission beam information and the reception beam information may be an azimuth angle and an elevation angle of the transmission beam and an azimuth angle and an elevation angle of the reception beam, in the first coordinate system, the first direction configuring unit may configure the first direction based on the azimuth angle and the elevation angle of the transmission beam, and the second direction configuring unit may configure the second direction based on the azimuth angle and the elevation angle of the reception beam.

Furthermore, in the location server according to the aspect of the present invention, the transmission beam information and the reception beam information may be a vector of the transmission beam and a vector of the reception beam, in the first coordinate system, the first direction configuring unit may configure the first direction based on the vector of the transmission beam, and the second direction configuring unit may configure the second direction based on the vector of the reception beam.

Furthermore, in the location server according to the aspect of the present invention, the direction managing unit may estimate whether or not there is reflection between the transmission beam and the reception beam, and may measure the orientation based on the first direction and the second direction of the transmission beam and the reception beam between which there is none of the reflection.

A method according to an aspect of the present invention is a method in a terminal apparatus for communicating with multiple transmission devices using beamforming, the method includes the steps of: receiving transmission beam information that is information of a transmission beam used by the transmission device and configuring a first direction that is a direction vector of the transmission beam in a first coordinate system based on the transmission beam information; configuring a reception beam used for reception of a signal from the transmission device; configuring a second direction that is a direction vector of the reception beam in a second coordinate system; and performing measurement of an orientation of the terminal apparatus itself based on the first direction and the second direction.

### Advantageous Effects of Invention

According to one or multiple aspects of the present invention, a terminal apparatus can estimate an orientation of the terminal apparatus itself with high accuracy.

### BRIEF DESCRIPTION OF DRAWINGS

FIG. 1 is a schematic block diagram illustrating a configuration example of a communication system according to a first embodiment.

FIG. 2 is a schematic block diagram illustrating an example of communication among apparatuses of the communication system according to the first embodiment.

FIG. 3 is a diagram illustrating an example of a case in which a base station apparatus and a terminal apparatus determine a beam using beam sweeping.

FIG. 4 is a diagram illustrating an example of a relationship between a base station apparatus and a terminal antenna of a terminal apparatus.

FIG. 5 is a schematic block diagram illustrating a configuration example of a base station apparatus according to the first embodiment.

FIG. 6 is a schematic block diagram illustrating a configuration example of a terminal apparatus according to the first embodiment.

FIG. 7 is a schematic block diagram illustrating a configuration example of a location server.

FIG. 8 is a schematic block diagram illustrating a configuration example of a terminal apparatus according to a second embodiment.

FIG. 9 is a schematic block diagram illustrating a configuration example of a location server according to the second embodiment.

### DESCRIPTION OF EMBODIMENTS

### First Embodiment

A communication system according to the present embodiment includes a base station apparatus (a transmission device, a cell, a transmission point, a group of transmit antennas, a group of transmit antenna ports, a component carrier, eNodeB, and an access point), a terminal apparatus (a terminal, a mobile terminal, a reception point, a reception terminal, a reception device, a group of receive antennas, a group of receive antenna ports, UE, a station), and a location server. The location server includes, for example, an Enhanced Serving Mobile Location Centre (E-SMLC), a Secure User Plane Location (SUPL), and an SUPL Location Platform (SLP). Furthermore, a base station apparatus connected to a terminal apparatus (base station apparatus that establishes a radio link with a terminal apparatus) is referred to as a serving cell.

The base station apparatus and the terminal apparatus in the present embodiment can communicate in a licensed band and/or an unlicensed band.

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

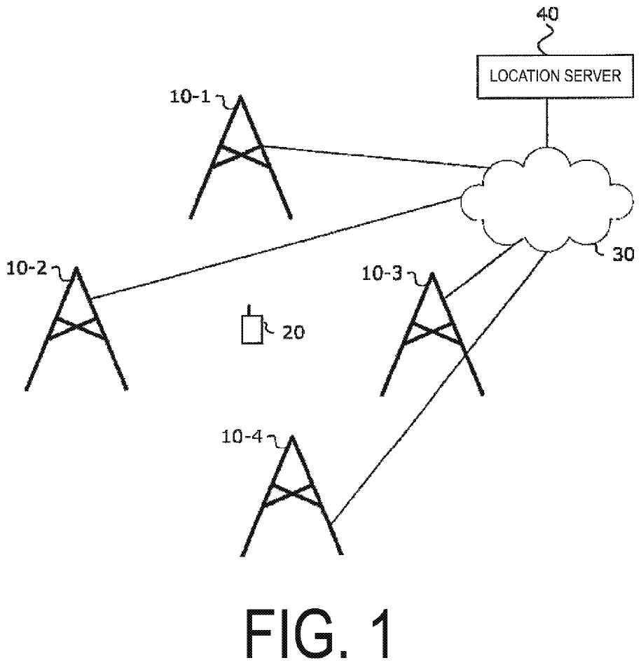

FIG. 1 is a diagram illustrating an example of a communication system according to the present embodiment. As illustrated in FIG. 1, the communication system according to the present embodiment includes base station apparatuses 10-1, 10-2, 10-3, and 10-4, a terminal apparatus 20, a core network 30, and a location server 40. The base station apparatuses 10-1, 10-2, 10-3, and 10-4 perform radio communication with the terminal apparatus 20. Additionally, the base station apparatuses 10-1, 10-2, 10-3, and 10-4 are connected to the location server 40 via the core network 30. The location server 40 can support location estimation and orientation estimation of the terminal apparatus 20. Here, the orientation refers to an orientation (direction) of the terminal apparatus 20 in a global coordinate system, for example. Note that the orientation is not limited to that in the global coordinate system, and may be the orientation of the terminal apparatus 20 in a coordinate system shared by a base station apparatus 10 and/or the location server 40 and the terminal apparatus 20. As described later, the terminal apparatus 20 and the location server 40 perform communication by a positioning protocol (e.g. LPP), this communication is relayed by the base station apparatuses 10-1, 10-2, 10-3, and 10-4 and the core network 30. Additionally, the location server 40 and the base station apparatuses 10-1, 10-2, 10-3, and 10-4 perform communication by a positioning protocol A (e.g., LPPa), this communication is relayed by the core network 30. The base station apparatuses 10-1, 10-2, 10-3, and 10-4 and the terminal apparatus 20 communicate using beamforming. Note that although the description is given using the four base station apparatuses, more or fewer apparatuses than this may be used.

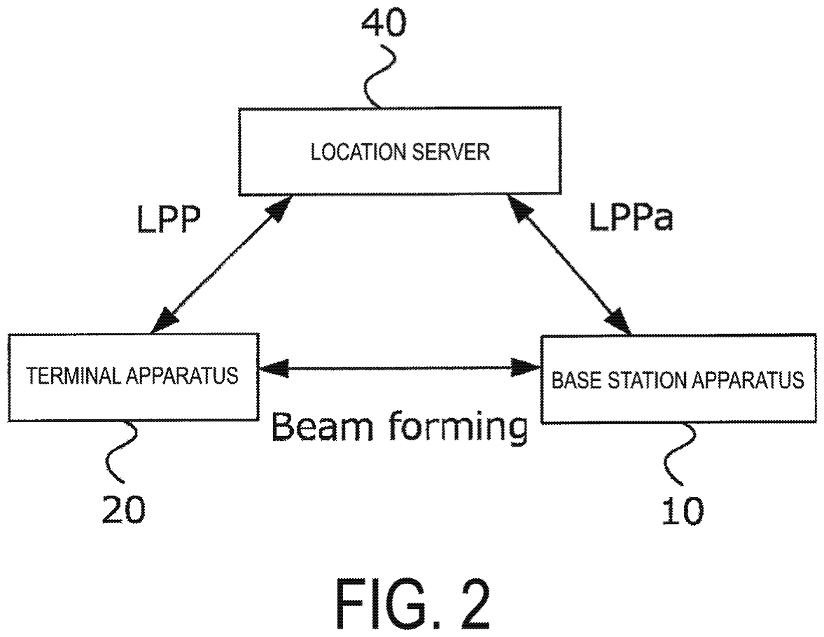

FIG. 2 is a schematic block diagram illustrating communication among apparatuses of the communication system according to the present embodiment. In FIG. 1, the communication system includes the four base station apparatuses 10-1, 10-2, 10-3, and 10-4, but the base station apparatus 10 in FIG. 2 is representative of these four base station apparatuses 10-1, 10-2, 10-3, and 10-4. As illustrated in FIG. 2, the base station apparatus 10 performs communication with the terminal apparatus 20 using the beamforming. The base station apparatus 10 performs communication with the location server 40 by the LPPa. The location server 40 can obtain, via the LPPa, a direction of a beam used by the base station apparatus 10. Here, the direction of the beam can be a direction vector or a set of an azimuth angle and an elevation angle in the global coordinate system. The global coordinate system can be, for example, a right-handed coordinate system in which an x axis is taken as the east direction, a y axis is taken as the north direction, and a z axis is taken as the zenith direction. The terminal apparatus 20 performs communication with the location server 40 by the LPP. The terminal apparatus 20 can receive, via the LPP, the direction of the transmission beam used by the base station apparatus 10 from the location server 40.

Note that the terminal apparatus 20 may receive the location of the base station apparatus 10 from the location server 40. In this case, the terminal apparatus 20 can estimate the direction from the base station apparatus 10 to the terminal apparatus 20 by measuring the location of the terminal apparatus.

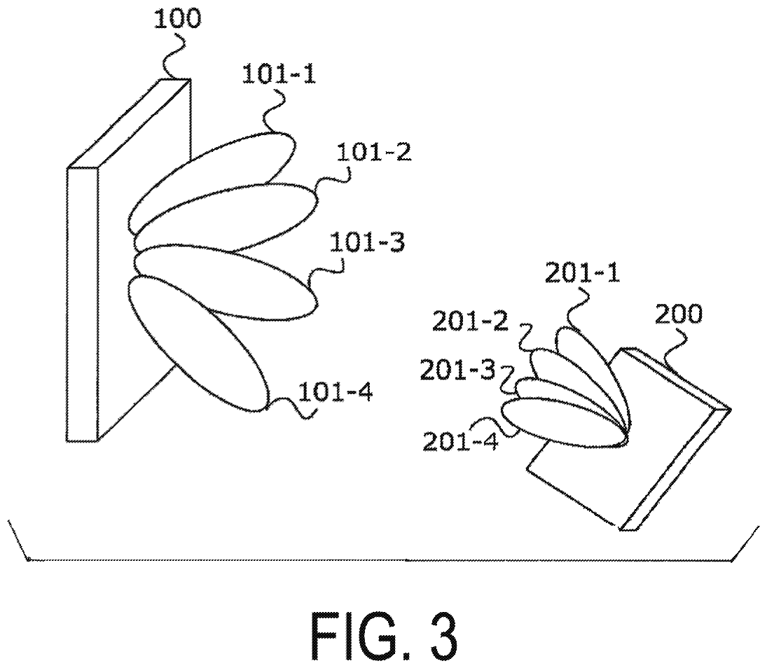

FIG. 3 is a diagram illustrating an example of a case in which the base station apparatus 10 and the terminal apparatus 20 determine a beam using beam sweeping. Note that for the beam sweeping, a reference signal (a positioning reference signal, a channel state information reference signal, a cell-specific reference signal, or the like) or a synchronization signal can be used. In FIG. 3, a base station antenna 100 includes base station beam candidates 101-1, 101-2, 101-3, and 101-4. In FIG. 3, a terminal antenna 200 includes terminal beam candidates 201-1, 201-2, 201-3, and 201-4. For example, the base station apparatus 10 can transmit a signal, by using the base station beam candidate 101-1 as a transmission beam, to the terminal apparatus 20. At this time, the terminal apparatus 20 can receive the signal from the base station apparatus 10, by using the terminal beam candidates 201-1, 201-2, 201-3, and 201-4 as a reception beam. The terminal apparatus 20 can make the beam candidate, among the terminal beam candidates 201-1, 201-2, 201-3, and 201-4, in which a Signal to Noise Ratio (SNR), a beam gain, Reference Signal Received Power (RSRP), Reference Signal Received Quality (RSRQ), or the like is maximized, a reception beam. Furthermore, the base station apparatus 10 can attempt signal transmission using a beam candidate 101-m (m=2, . . . , 4) as the transmission beam at any time. For each m, the terminal apparatus 20 can choose a reception beam in which the SNR is maximized from among beam candidates 201-n (n=1, . . . , 4). As a result of the above-described searching process, from among 4² transmission and/or reception beam patterns that can be taken, it is possible to make, in a case that the SNR is maximized, the base station beam candidate 101-m the transmission beam of the base station apparatus 10 and the terminal beam candidate 201-n the reception beam of the terminal apparatus 20. Note that in the above description, the number of base station beam candidates and the number of terminal beam candidates are described as four, but the number may be greater or less than this. Note that in the above description, the case that the base station apparatus 10 performs transmission and the terminal apparatus 20 performs reception has been described, but the terminal apparatus 20 may perform transmission and the base station apparatus 10 may perform reception. Additionally, the m base station beam candidates described above may be all possible beam candidates by the base station apparatus 10, or may be some beam candidates thereof. Additionally, the n terminal beam candidates described above may be all possible beam candidates by the terminal apparatus 20, or may be some beam candidates thereof. Additionally, the beam candidate described above may also be a horizontal beam or a vertical beam. In this case, each of the base station apparatus 10/the terminal apparatus 20 searches for the suitable horizontal beam and vertical beam. Note that in the following embodiments, a vertical direction of the antenna is also referred to as a first dimension and a horizontal direction of the antenna is also referred to as a second dimension.

The base station apparatus 10 reports the base station beam direction of the determined base station beam candidate in the global coordinate system to the location server 40 via the LPPa. The location server 40 notifies the terminal apparatus 20 of the base station beam direction via the LPP.

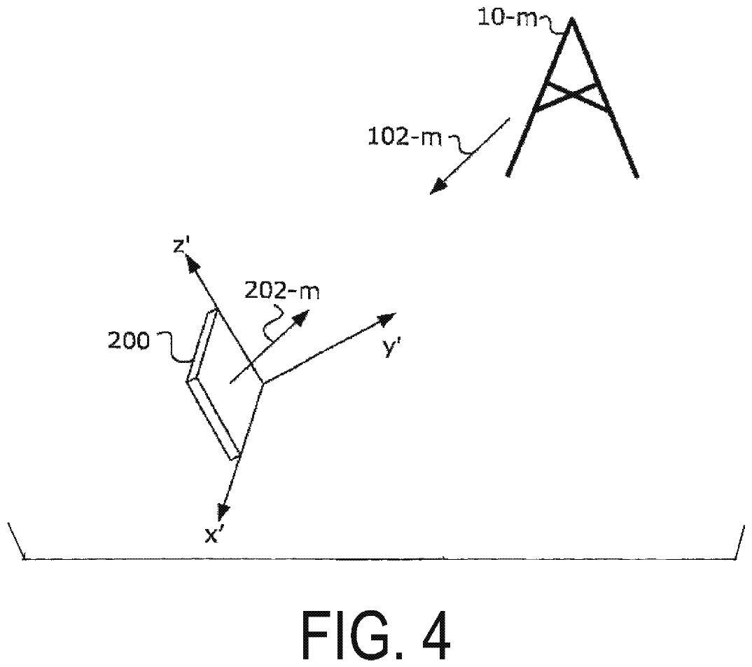

FIG. 4 is a diagram illustrating a relationship between a base station apparatus 10-m and the terminal antenna 200 of the terminal apparatus 20. In FIG. 4, the terminal antenna 200 is a planar antenna on a plane formed by an x′ axis and a z′ axis of a local coordinate system of the terminal 20. A base station beam direction 102-m and a terminal beam direction 202-m can be determined by the above-described beam sweeping and the like. An example of estimating the orientation of the terminal apparatus 20 will be described below, by estimating a rotation matrix from the global coordinate system to the local coordinate system of the terminal apparatus 20. A direction vector obtained by multiplying the vector representing the base station beam direction 102-m in the global coordinate system by −1 is taken as cₘ, and a vector representing the terminal beam direction 202-m in the local coordinate system of the terminal apparatus 20 is taken as eₘ. The number of base station apparatuses is taken as M. Note that FIG. 1 illustrates an example in the case of M=4. In this case, in a case that a 3×M dimensional matrix is taken as C in which the direction vectors cₘ in the global coordinate system are arranged in order of m=1, M, C=(c₁, . . . , c_{M}) is obtained. In the same manner, in a case that a 3×M dimensional matrix is taken as E in which the direction vectors eₘ in the local coordinate system are arranged in order of m=1, M, E=(e₁, . . . , e_{M}) is obtained. Next, a result of performing singular value decomposition on a 3×3 matrix M=CE^{T} obtained by multiplying C and E^{T} is taken as USV^{T}. Note that ^{T} represents a transposition, U is a 3×3 dimensional orthogonal matrix, S is a 3×3 dimensional diagonal matrix, and V^{T} is a 3×3 dimensional orthogonal matrix. At this time, a rotation matrix R from the global coordinate system to the local coordinate system can be estimated as R=Vdiag[1, 1, det(VU^{T})] U^{T}. Note that diag( ) represents a diagonal matrix in which the arguments are diagonally arranged, and det( ) represents a determinant of a matrix indicated by the argument.

Next, an example of estimating the orientation of the terminal apparatus 20 will be described, by estimating a quaternion from the global coordinate system to the local coordinate system. The quaternion can be expressed by the sum of a scalar and a three-dimensional vector. The right-hand screw rotation of an angle θ with a certain direction vector n as an axis can be represented by a quaternion that is cos(0.5θ)+nsin(0.5θ). In this case as well, the matrix M described above is used. A p-row q-column component of the matrix M is taken as m_{pq}. Next, a 4×4 dimensional matrix N, such as Equation (1) below, is calculated.

$$\begin{matrix}Equation 1 & \\ N = ( \begin{matrix}{m}_{11} + {m}_{22} + {m}_{33} & {m}_{23} - {m}_{32} & {m}_{31} - {m}_{13} & {m}_{12} - {m}_{21} \\ {m}_{23} - {m}_{32} & {m}_{11} - {m}_{22} - {m}_{33} & {m}_{12} + {m}_{21} & {m}_{31} + {m}_{13} \\ {m}_{31} - {m}_{13} & {m}_{12} + {m}_{21} & - {m}_{11} + & {m}_{23} + {m}_{32} \\ & & {m}_{22} - {m}_{33} & \\ {m}_{12} - {m}_{21} & {m}_{31} + {m}_{13} & {m}_{23} + {m}_{32} & - {m}_{11} - \\ & & & {m}_{22} + {m}_{33}\end{matrix} ) & ( 1 )\end{matrix}$$

N is subjected to eigenvalue decomposition, and a normalized eigenvector of size four corresponding to the maximum eigenvalue thereof is taken as b. In a case that the quaternion is expressed by the sum of the scalar and the three-dimensional vector, the quaternion in which a first component of a vector b is taken as the scalar portion and a three-dimensional vector including second, third, and fourth components of the vector b is taken as a vector portion is a quaternion to be obtained.

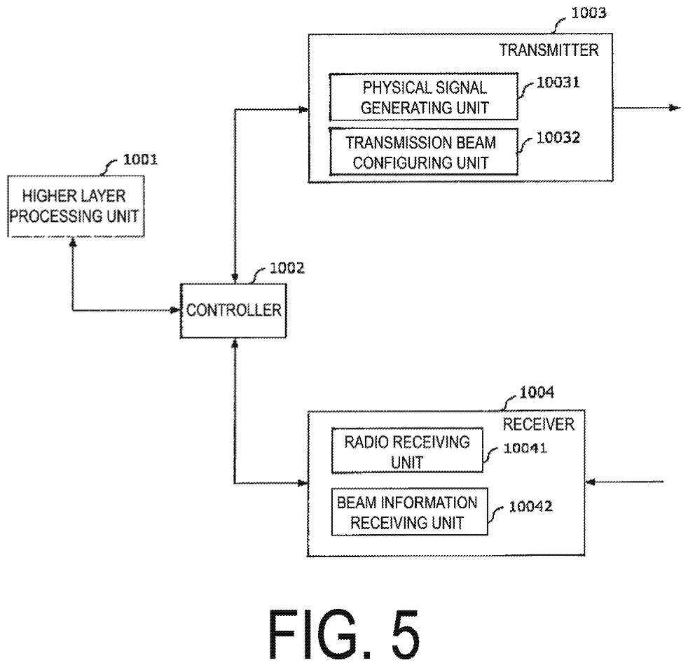

FIG. 5 is a schematic block diagram illustrating a configuration example of the base station apparatus 10 according to the present embodiment. As illustrated in FIG. 5, the base station apparatus 10 is configured to include a higher layer processing unit (higher layer processing step) 1001, a controller (controlling step) 1002, a transmitter (transmitting step) 1003, a receiver (receiving step) 1004, a physical signal generating unit (physical signal generating step) 10031, a transmission beam configuring unit (transmission beam configuring step) 10032, a radio receiving unit (radio receiving step) 10041, and a beam information receiving unit (beam information receiving step) 10042. Note that although not illustrated in the diagram, the transmitter 1003 may include a transmit antenna. Additionally, although not illustrated in the diagram, the receiver 1005 may include a receive antenna. Additionally, the transmit antenna and the receive antenna may be the same antenna.

The higher layer processing unit 1001 performs processing of a Medium Access Control (MAC) layer, a Packet Data Convergence Protocol (PDCP) layer, a Radio Link Control (RLC) layer, and a Radio Resource Control (RRC) layer. Furthermore, the higher layer processing unit 1001 generates information necessary for control of the transmitter 1003 and the receiver 1004, and outputs the generated information to the controller 1002.

The higher layer processing unit 1001 receives information of a terminal apparatus, such as a capability of the terminal apparatus (UE capability), from the terminal apparatus. To rephrase, the terminal apparatus transmits the function of the terminal itself to the base station apparatus by higher layer signaling.

Note that in the following description, information of a terminal apparatus includes information for indicating whether the terminal apparatus supports a prescribed function, or information for indicating that the terminal apparatus has completed the introduction and test of a prescribed function. In the following description, information of whether the prescribed function is supported includes information of whether the introduction and test of the prescribed function have been completed.

For example, in a case that a terminal apparatus supports a prescribed function, the terminal apparatus transmits information (parameters) for indicating whether the prescribed function is supported. In a case that a terminal apparatus does not support a prescribed function, the terminal apparatus does not transmit information (parameters) for indicating whether the prescribed function is supported. In other words, whether the prescribed function is supported is reported by whether information (parameters) indicating whether the prescribed function is supported is transmitted. The information (parameters) indicating whether the prescribed function is supported may be reported using one bit of 1 or 0.

The higher layer processing unit 1001 generates, or acquires from a higher node, downlink data (transport block), system information, an RRC message, a MAC Control Element (CE), and the like. The higher layer processing unit 1001 outputs the downlink data to the transmitter 1003, and outputs other information to the controller 1002. Furthermore, the higher layer processing unit 1001 manages various types of configuration information about the terminal apparatus.

The higher layer processing unit 1001 determines a frequency and a subframe to which a physical channel is allocated, a coding rate and modulation scheme (or MCS) for the physical channel, transmit power, and the like. The higher layer processing unit 1001 outputs the determined information to the controller 1002.

The higher layer processing unit 1001 generates information to be used for scheduling the physical channel, based on the result of the scheduling. The higher layer processing unit 1001 outputs the generated information to the controller 1002.

Based on the information input from the higher layer processing unit 1001, the controller 1002 generates a control signal for controlling the transmitter 1003 and the receiver 1004. The controller 1002 generates downlink control information based on the information input from the higher layer processing unit 1001, and outputs the generated information to the transmitter 1003.

The transmitter 1003 generates a downlink reference signal in accordance with the control signal input from the controller 1002, codes and modulates an HARQ indicator, the downlink control information, and the downlink data that are input from the higher layer processing unit 1001, multiplexes the downlink physical channel and the downlink reference signal, and transmits a signal obtained through the multiplexing to the terminal apparatus 20 through the transmit and/or receive antenna.

The physical signal generating unit 10031 generates an Orthogonal Frequency Division Multiplexing (OFDM) signal from the HARQ indicator, the downlink control information, the downlink reference signal, and the downlink data input from the higher layer processing unit 1001. A cyclic prefix (CP) is added to the OFDM symbol, and a baseband digital signal is generated. The baseband digital signal is converted into an analog signal, excess frequency components are removed therefrom by filtering, up-conversion to a carrier frequency is performed, power amplification is performed, and the resultant signal is output through the transmit antenna. Note that the generated signal is not limited to the OFDM signal, and may be a single carrier signal, a Code Division Multiple Access (CDMA) signal, or the like.

The transmission beam configuring unit 10032 configures the transmission beam used by the base station apparatus 10. For example, the transmission beam configuring unit 10032 can configure the transmission beam by using the beam sweeping. Specifically, it is possible to configure the transmission beam candidate, which is received by the beam information receiving unit 10042 described later, with the maximum SNR in the terminal apparatus 20, to the transmission beam. The transmission beam configuring unit 10032 can report a direction of the configured transmission beam in the global coordinate system to the location server 40 via the higher layer processing unit 1001. Information relating to the direction of the transmission beam can be referred to as transmission beam information.

In accordance with the control signal input from the controller 1002, the radio receiving unit 10041 demultiplexes, demodulates, and decodes a reception signal received from the terminal apparatus, and outputs information resulting from the decoding to the higher layer processing unit 1001 or the beam information receiving unit 10042.

The radio receiving unit 10041 converts, by down-conversion, an uplink signal received through the receive antenna into a baseband signal, removes unnecessary frequency components from the baseband signal, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 10041 removes a portion corresponding to the CP from the digital signal resulting from the conversion. The radio receiving unit 10041 performs Fast Fourier Transform (FFT) on the signal from which the CP has been removed, and extracts a signal in the frequency domain. The extracted signal in the frequency domain is demultiplexed into an uplink physical channel, a signal such as an uplink reference signal, and the like.

The radio receiving unit 10041 performs Inverse Discrete Fourier Transform (IDFT) of PUSCH/NPUSCH, acquires a modulation symbol, and demodulates the reception signal. Note that IFFT corresponding to the number of points of the above-described inverse discrete Fourier transform may be used.

The radio receiving unit 10041 decodes the coded bits that have been demodulated, at a coding rate, in compliance with a predetermined coding scheme, that is predetermined or notified from the base station apparatus to the terminal apparatus 20 in advance by using the uplink grant, and outputs the decoded uplink data and uplink control information to the higher layer processing unit 1001. In a case that the PUSCH is retransmitted, the decoding is performed by using the coded bits input from the higher layer processing unit 1001 and retained in an HARQ buffer, and the demodulated coded bits.

The beam information receiving unit 10042 receives beam information from the terminal apparatus 20 necessary for the transmission beam configuring unit 10032 to configure the transmission beam. Here, the beam information is, for example, identification information of the transmission beam in which the SNR measured by the terminal apparatus 20 is maximized at the time of the beam sweeping. The identification information may be, for example, a transmission beam number (transmission beam index) or a resource number (resource index).

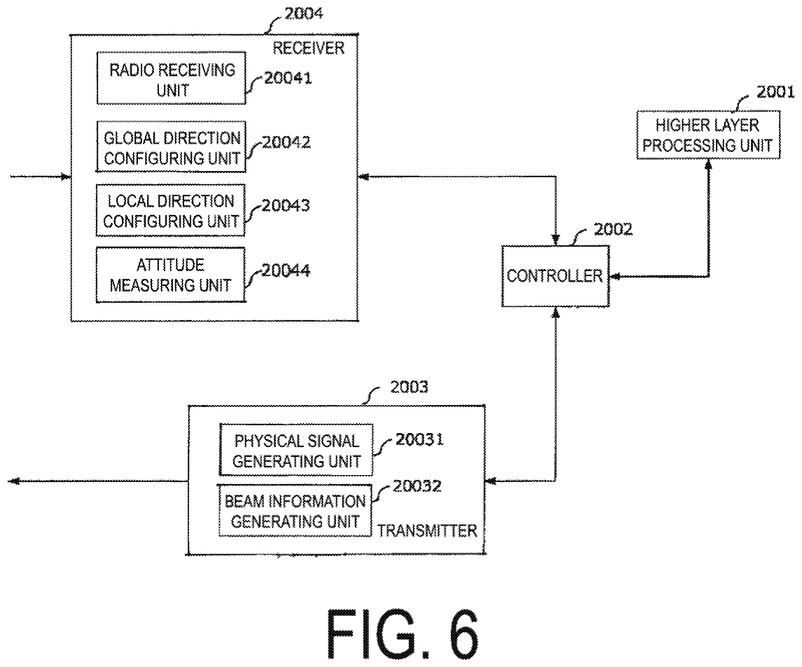

FIG. 6 is a schematic block diagram illustrating a configuration of the terminal apparatus 20 according to the present embodiment. As illustrated in FIG. 6, the terminal apparatus 20 is configured to include a higher layer processing unit (higher layer processing step) 2001, a controller (controlling step) 2002, a transmitter (transmitting step) 2003, and a receiver (receiving step) 2004. Furthermore, the transmitter 2003 is configured to include a physical signal generating unit (physical signal generating step) 20031, a beam information generating unit (beam information generating step) 20032, and a local direction configuring unit (second direction configuring unit, local direction configuring step, second direction configuring step) 20033. The receiver 2004 is configured to include a radio receiving unit (radio receiving step) 20041, a global direction configuring unit (first direction configuring unit, global direction configuring step, first direction configuring step) 20042, and an orientation measuring unit (orientation measuring step) 20044.

The higher layer processing unit 2001 outputs, to the transmitter 2003, uplink data (transport block) generated by a user operation or the like. Additionally, the higher layer processing unit 2001 performs processing of the Medium Access Control (MAC) layer, the Packet Data Convergence Protocol (PDCP) layer, the Radio Link Control (RLC) layer, the Radio Resource Control (RRC) layer, and the like.

The higher layer processing unit 2001 outputs, to the transmitter 2003, information for indicating a terminal apparatus function supported by the terminal apparatus.

The higher layer processing unit 2001 manages various types of configuration information about the terminal apparatus. Furthermore, the higher layer processing unit 2001 generates information to be mapped to each uplink channel, and outputs the generated information to the transmitter 2003.

The higher layer processing unit 2001 interprets the downlink control information received through the receiver 2004, and determines scheduling information. Furthermore, the higher layer processing unit 2001 generates control information in order to control the receiver 2004 and the transmitter 2003 in accordance with the scheduling information, and outputs the generated information to the controller 2002.

The higher layer processing unit 2001 interprets the data (information) required for the orientation measurement, such as direction information or the like of the transmission beam of the base station apparatus 10-m, from the location server 40, and outputs the result to the controller 2002.

Based on the information input from the higher layer processing unit 2001, the controller 2002 generates a control signal for controlling the receiver 2004 and the transmitter 2003. The controller 2002 outputs the generated control signal to the receiver 2004 and the transmitter 2003 to control the receiver 2004 and the transmitter 2003.

In accordance with the control signal input from the controller 2002, the receiver 2004 demultiplexes, demodulates, and decodes a reception signal received from the base station apparatus through the receive antenna, and outputs the decoded information to the higher layer processing unit 2001.

The radio receiving unit 20041 converts, by down-conversion, a downlink signal received through the transmit and/or receive antenna into a baseband signal, removes unnecessary frequency components from the baseband signal, controls an amplification level in such a manner as to suitably maintain a signal level, orthogonally demodulates the signal based on an in-phase component and an orthogonal component of the received signal, and converts the resulting orthogonally-demodulated analog signal into a digital signal.

The radio receiving unit 20041 removes a portion corresponding to the CP from the digital signal resulting from the conversion, performs fast Fourier transform of the signal from which the CP has been removed, and extracts a signal in the frequency domain. The extracted signal is demultiplexed into the downlink physical channel and the downlink reference signal. Furthermore, the radio receiving unit 20041 performs channel compensation for the downlink physical channel based on a channel estimation value of a desired signal obtained from channel measurement, detects downlink control information, and outputs the detected downlink control information to the controller 2002.

The radio receiving unit 20041, by using the channel estimation value, detects a signal, and outputs the detected signal to the higher layer processing unit 2001.

The radio receiving unit 20041 configures the reception beam. For example, the beam sweeping is performed with the base station apparatus 10-m, and a beam in which the SNR is maximized is configured to the reception beam. Information relating to the direction of the reception beam can be referred to as reception beam information.

The global direction configuring unit 20042 configures a global direction vector, which is a direction vector from the base station apparatus 10-m to the terminal apparatus 20 in the global coordinate system, based on the direction of the transmission beam. The global direction configuring unit 20042 outputs the configured global direction vector to the orientation measuring unit 20044.

The local direction configuring unit 20043 configures a local direction vector, which is a direction vector of the reception beam configured by the radio receiving unit 20041 in the local coordinate system. The local direction configuring unit 20043 outputs the configured local direction vector to the orientation measuring unit 20044.

The orientation measuring unit 20044 measures the orientation of the terminal apparatus based on the global direction input from the global direction configuring unit 20042 and the local direction input from the local direction configuring unit 20043.

The orientation measuring unit 20044 may receive beam orientation measurement information, from the location server 40, indicating whether or not the transmission beam is to be used for the orientation measurement. For example, in a case that the transmission beam used by the base station apparatus 10-m is received by the reception beam of the terminal apparatus 20 through reflection, it is preferable that this transmission beam be removed from the orientation measurement. The accuracy of the orientation measurement can be improved by using the transmission beam indicated by the beam orientation measurement information.

The transmitter 2003 generates the uplink reference signal in accordance with the control signal input from the controller 2002, codes and modulates the uplink data (transport block) input from the higher layer processing unit 2001, multiplexes the uplink physical channel such as a control channel, a shared channel, or the like, and the generated uplink reference signal, and transmits a signal resulting from the multiplexing to the base station apparatus through the transmit antenna.

The physical signal generating unit 20031 generates an SC-FDMA symbol from the uplink control information, the uplink data, and the uplink reference signal. A CP is added to the SC-FDMA symbol, and a baseband digital signal is generated. The baseband digital signal is converted into an analog signal, excess frequency components are removed therefrom, conversion into a carrier frequency by up-conversion is performed, power amplification is performed, and the resultant signal is transmitted.

Note that the terminal apparatus can perform modulation according to not only the SC-FDMA scheme but also the OFDMA scheme and the CDMA scheme.

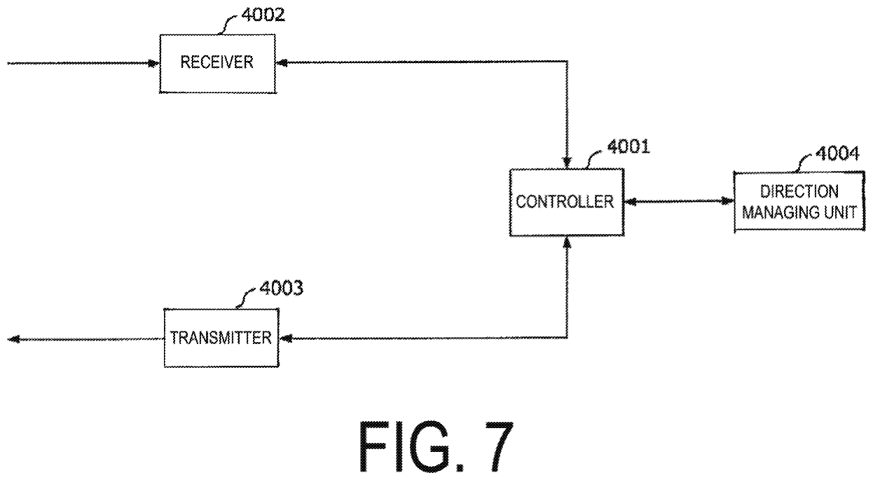

FIG. 7 is a schematic block diagram illustrating a configuration example of the location server 40. The location server 40 is configured to include a controller (controlling step) 4001, a receiver (receiving step) 4002, a transmitter (transmitting step) 4003, and a direction managing unit (direction managing step) 4004.

The controller 4001 controls the receiver 4002, the transmitter 4003, and the direction managing unit 4004.

The receiver 4002 receives the direction of the transmission beam used by the base station apparatus 10-m for the terminal apparatus 20, and outputs the received direction to the controller 4001. Alternatively, the receiver 4002 receives the identification information of the transmission beam used by the base station apparatus 10-m for the terminal apparatus 20, and outputs the information to the controller 4001. The controller 4001 outputs the direction of the transmission beam or the identification information of the transmission beam to the direction managing unit 4004. The direction managing unit 4004 receives and stores the direction of the transmission beam. Alternatively, the direction managing unit 4004 receives the identification information of the transmission beam, determines the direction of the transmission beam based on relevant information of the transmission beam and the direction in the base station apparatus 10-m, and stores the determined direction. As information addressed to the terminal apparatus 20, the direction managing unit 4004 outputs the direction of the transmission beam of the base station apparatus 10-m to the controller 4001.

The direction managing unit 4004 may estimate the location of the terminal apparatus 20. For example, by assuming that the location of the base station apparatus 10-m is known, the location of the terminal apparatus 20 can be calculated from the direction of each transmission beam. At this time, it is possible to determine whether or not each of the transmission beams is through reflection. In a case of determining as the reflection, the beam orientation measurement information indicating whether or not the transmission beam is used for the orientation measurement can be configured to No and output it to the controller 4001 as information addressed to the terminal apparatus 20.

As information addressed to the terminal apparatus 20, the controller 4001 outputs the direction of the transmission beam of the base station apparatus 10-m to the transmitter 4003. As information addressed to the terminal apparatus 20, the transmitter 4003 transmits the direction of the transmission beam of the base station apparatus 10-m. The same applies to the beam orientation measurement information.

As described above, according to the present embodiment, the terminal apparatus can measure the orientation of the terminal apparatus with high accuracy.

### Second Embodiment

In the first embodiment, the terminal apparatus measures the orientation of the terminal apparatus based on the direction of the transmission beam of the base station apparatus received from the location server and the direction of the reception beam used by the terminal apparatus. In the present embodiment, a method will be described in which the terminal apparatus reports the direction of the reception beam to the location server, and the location server estimates the orientation of the terminal apparatus.

A configuration of the base station apparatus 10 according to the present embodiment is the same as that in FIG. 5. However, an operation of the beam information receiving unit 10042 is different. In the present embodiment, the beam information receiving unit 10042 receives the direction of the reception beam used by the terminal apparatus 20. The received information of the direction is transmitted to the location server 40 via the controller 1002 and the higher layer processing unit 1001.

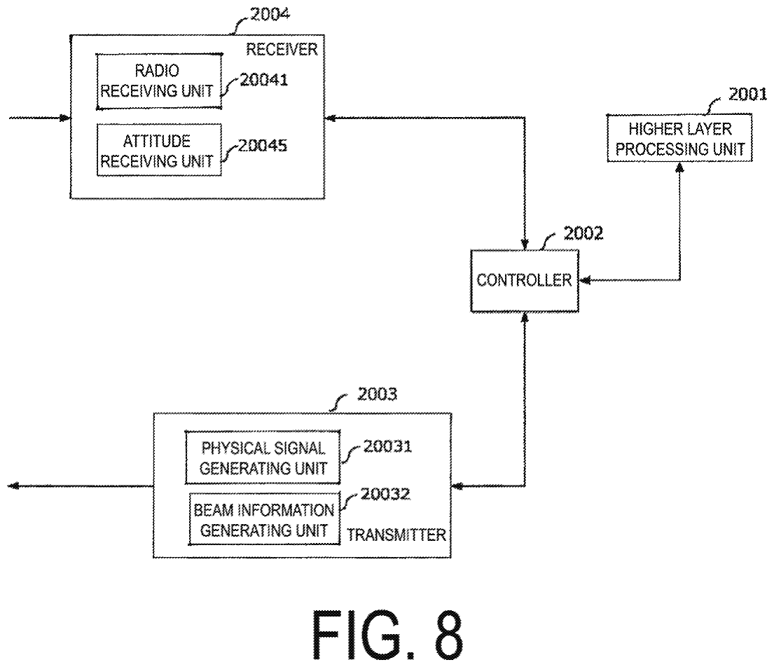

FIG. 8 is a schematic block diagram illustrating a configuration example of the terminal apparatus 20 according to the present embodiment. In a case of comparing FIG. 8 with the terminal apparatus 20 according to the first embodiment (FIG. 6), the global direction configuring unit 20042, the local direction configuring unit 20043, and the orientation measuring unit 20044 are not included, and an orientation receiving unit (orientation receiving step) 20045 is included. The orientation receiving unit 20045 receives the orientation of the terminal apparatus 20 calculated by the location server 40. This reception processing may be carried out via the higher layer processing unit 2001 and the controller 2002.

Furthermore, the operation of the beam information generating unit 20032 is different from that of the first embodiment. In the present embodiment, the beam information generating unit 20032 generates the direction of the reception beam for the base station apparatus 10-m used by the terminal apparatus 20, and transmits the generated direction via the transmitter 2003.

Other functions are the same as in the schematic block diagram (FIG. 6) illustrating the configuration example of the terminal apparatus 20 according to the first embodiment. Description of the blocks having the same function will be omitted.

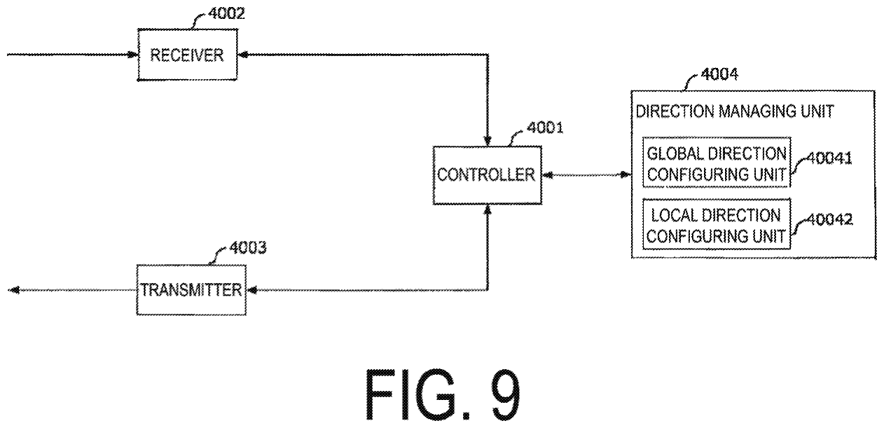

FIG. 9 is a schematic block diagram illustrating a configuration example of the location server 40 according to the present embodiment.

The receiver 4002 receives the direction of the reception beam used by the terminal apparatus 20 for the base station apparatus 10-m, and outputs the received direction to the controller 4001. Furthermore, the direction managing unit 4004 receives the direction of the transmission beam used by the base station apparatus 10-m for the terminal apparatus 20, and outputs the received direction to the controller 4001.

In addition, since the operation of the direction managing unit 4004 is different, this will be described. The direction managing unit 4004 includes a global direction configuring unit (first direction configuring unit, global direction configuring step, first direction configuring step) 40041 and a local direction configuring unit (second direction configuring unit, local direction configuring step, second direction configuring step) 40042 in the inside. The global direction configuring unit 40041 configures the first direction, which is the direction vector of the transmission beam of the base station apparatus 10-m in the global coordinate system, based on the direction of the transmission beam input from the controller 4001. Note that the first direction may be a direction of the terminal apparatus 20 with respect to the base station apparatus 10-m. The local direction configuring unit 40042 configures the second direction, which is the direction vector of the reception beam of the terminal apparatus 20 in the local coordinate system, based on the direction of the reception beam input from the controller 4001. Note that the second direction may be a direction of the base station apparatus 10-m with respect to the terminal apparatus 20. The direction managing unit 4004 measures the orientation of the terminal apparatus 20 based on the first direction and the second direction. This measurement may be performed with the exception of a pair of the transmission beam and the reception beam that are through the reflection. The direction managing unit 4004 outputs the measured orientation to the controller 4001.

In addition, since the operation of the transmitter 4003 is different, this will be described. The transmitter 4003 transmits the orientation of the terminal apparatus 20 as information addressed to the terminal apparatus 20.

As described above, according to the present embodiment, by using the direction of the transmission beam and the direction of the reception beam, the location server can measure the orientation of the terminal apparatus with high accuracy. Additionally, the terminal apparatus can receive the highly accurate orientation.

Note that in the above-described embodiments, although the direction of the transmission beam/the direction of the reception beam are estimated by the beam sweeping, an aspect of the present invention is not limited thereto, the direction of the transmission beam/the direction of the reception beam may be estimated by arrival direction estimation.

A program running on each of the terminal apparatus, the location server, and the method in the terminal apparatus according to an aspect of the present invention is a program (a program for causing a computer to operate) that controls a CPU and the like in such a manner as to realize the functions according to an aspect of the above-described embodiments of the present invention. The information handled by these devices is temporarily held in a RAM at the time of processing, and is then stored in various types of ROMs, HDDs, and the like, and read out by the CPU as necessary to be edited and written. Here, a semiconductor medium (ROM, a non-volatile memory card, or the like, for example), an optical recording medium (DVD, MO, MD, CD, BD, or the like, for example), a magnetic recording medium (magnetic tape, a flexible disk, or the like, for example), and the like can be given as examples of recording media for storing the programs. In addition to realizing the functions of the above-described embodiments by performing loaded programs, functions according to an aspect of the present invention can be realized by the programs running cooperatively with an operating system, other application programs, or the like in accordance with instructions included in those programs.

In a case of delivering these programs to market, the programs can be stored in a portable recording medium, or transferred to a server computer connected via a network such as the Internet. In this case, storage devices in the server computer are also included in an aspect of the present invention. Furthermore, some or all portions of each of the terminal apparatus, the location server, and the method in the terminal apparatus in the above-described embodiments may be realized as LSI, which is a typical integrated circuit. The functional blocks of each reception device may be individually realized as chips, or may be partially or completely integrated into a chip. In a case that the functional blocks are integrated into a chip, an integrated circuit controller for controlling them is added.

The circuit integration technique is not limited to LSI, and the integrated circuits for the functional blocks may be realized as dedicated circuits or a multi-purpose processor. Furthermore, in a case that with advances in semiconductor technology, a circuit integration technology with which an LSI is replaced appears, it is also possible to use an integrated circuit based on the technology.

Note that the invention of the present patent application is not limited to the above-described embodiments. It goes without saying that a video generating method according to an aspect of the invention of the present application is not limited to application to a glasses-type terminal, and can be applied to a portable device, a wearable device, or the like.

The embodiments according to an aspect of the invention have been described in detail thus far with reference to the drawings, but the specific configuration is not limited to the embodiments according to the aspect. Other designs and the like that do not depart from the essential spirit of the invention also fall within the scope of the patent claims.

### INDUSTRIAL APPLICABILITY

An aspect of the present invention can be suitably used in a terminal apparatus, a location server, and a method in the terminal apparatus. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

10, 10-1, 10-2, 10-3, 10-4, 10-m Base station apparatus
100 Base station antenna
101-1, 101-2, 101-3, 101-4 Base station beam candidate
102-m Base station beam direction
1001 Higher layer processing unit
1002 Controller
1003 Transmitter
10031 Physical signal generating unit
10032 Transmission beam configuring unit
1004 Receiver
10041 Radio receiving unit
10042 Beam information receiving unit
20 Terminal apparatus
200 Terminal antenna
201-1, 201-2, 201-3, 201-4 Terminal beam candidate
202-m Terminal beam direction
2001 Higher layer processing unit
2002 Controller
2003 Transmitter
20031 Physical signal generating unit
20032 Beam information generating unit
2004 Receiver
20041 Radio receiving unit
20042 Global direction configuring unit
20043 Local direction configuring unit
20044 Orientation measuring unit
20045 Orientation receiving unit
30 Core network
40 Location server
4001 Controller
4002 Receiver
4003 Transmitter
4004 Direction managing unit
40041 Global direction configuring unit
40042 Local direction configuring unit

1. A terminal apparatus comprising:
a first direction configuring unit configured to receive transmission beam information that is information of a transmission beam used by a transmission device and configure a first direction that is a direction vector of the transmission beam in a first coordinate system based on the transmission beam information;
a radio receiving unit configured to configure a reception beam used for reception of a signal from the transmission device;
a second direction configuring unit configured to configure a second direction that is a direction vector of the reception beam in a second coordinate system; and
an orientation measuring unit configured to perform measurement of an orientation of the terminal apparatus itself based on the first direction and the second direction.

2. The terminal apparatus according to claim 1,
wherein the transmission beam information is an azimuth angle and an elevation angle of the transmission beam used by the transmission device, in the first coordinate system, and
the first direction configuring unit configures the first direction based on the azimuth angle and the elevation angle.

3. The terminal apparatus according to claim 1,
wherein the transmission beam information is the direction vector of the transmission beam used by the transmission device, in the first coordinate system, and
the first direction configuring unit configures the first direction based on the direction vector.

4. The terminal apparatus according to claim 1,
wherein the second coordinate system is a coordinate system fixed to the orientation.

5. The terminal apparatus according to claim 1,
wherein the orientation measuring unit receives beam orientation measurement information for indicating Whether or not the transmission beam is used for orientation measurement, and
the orientation measuring unit performs the measurement based on the first direction and the second direction, corresponding to the transmission beam indicated by the beam orientation measurement information.

6. A location server in a system in which multiple base station apparatuses and a terminal apparatus communicate using beamforming, the location server comprising:
a receiver configured to receive transmission beam information that is information of a transmission beam used by the base station apparatus and reception beam information that is information of a reception beam used by the terminal apparatus;
a first direction configuring unit configured to configure a first direction that is a direction vector of the transmission beam in a first coordinate system based on the transmission beam information;
a second direction configuring unit configured to configure a second direction that is a direction vector of the reception beam in a second coordinate system of the terminal apparatus based on the reception beam information; and
a direction managing unit configured to perform measurement of an orientation of the terminal apparatus based on the first direction and the second direction.

7. The location server according to claim 6,
wherein the transmission beam information and the reception beam information are an azimuth angle and an elevation angle of the transmission beam and an azimuth angle and an elevation angle of the reception beam, in the first coordinate system,
the first direction configuring unit configures the first direction based on the azimuth angle and the elevation angle of the transmission beam, and
the second direction configuring unit configures the second direction based on the azimuth angle and the elevation angle of the reception beam.

8. The location server according to claim 6,
wherein the transmission beam information and the reception beam information are a vector of the transmission beam and a vector of the reception beam, in the first coordinate system,
the first direction configuring unit configures the first direction based on the vector of the transmission beam, and
the second direction configuring unit configures the second direction based on the vector of the reception beam.

9. The location server according to claim 6,
wherein the direction managing unit
estimates whether or not there is reflection between the transmission beam and the reception beam, and
measures the orientation based on the first direction and the second direction of the transmission beam and the reception beam between which there is none of the reflection.

10. A method in a terminal apparatus for communicating with multiple transmission devices using beamforming, the method comprising the steps of:
receiving transmission beam information that is information of a transmission beam used by the transmission device and configuring a first direction that is a direction vector of the transmission beam in a first coordinate system based on the transmission beam information;
configuring a reception beam used for reception of a signal from the transmission device;
configuring a second direction that is a direction vector of the reception beam in a second coordinate system; and
performing measurement of an orientation of the terminal apparatus itself based on the first direction and the second direction.
